(19) United States
(12) Patent Application Publication
(10) Pub. No.: US 2009/0031597 A1
(43) Pub. Date: Feb. 5, 2009

(54) BI-POSITIONAL WINE CELLARING LABEL

(76) Inventors: Francis M. Powell, Eden Prairie, MN (US); James L. Van Someren, Greenfield, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/183,576

(22) Filed: Jul. 31, 2008

Related U.S. Application Data
(60) Provisional application No. 60/963,112, filed on Aug. 2, 2007.
(60) Provisional application No. 61/072,435, filed on Mar. 31, 2008.

(51) Int. Cl. G09F 3/00; B42D 15/00

(52) U.S. Cl. 40/310; 283/70

(57) ABSTRACT

A bi-positional cellaring label for attaching to a wine bottle and displaying wine information. The label includes a first portion affixed to a wine bottle containing wine, and a second portion operably connected to the first portion and non-permanently affixed to the wine bottle, The second portion is adapted to be adjusted from a first position to a second position, and the second portion in the pre-cellaring position is located substantially adjacent the wine bottle, and in the cellaring position is located substantially perpendicular to the wine bottle. The label also includes indicia conveying information about the wine, printed upon the second portion, such that when the wine bottle is in a substantially horizontal position and the second portion is in the cellaring position, the indicia is viewable.

### RELATED APPLICATIONS

The present application claims priority to U.S. Provisional Application No. 60/963,112, filed Aug. 2, 2007, and entitled WINE BOTTLE LABEL, SYSTEM AND METHOD, and to U.S. Provisional Application No. 61/072,435, filed Mar. 31, 2008, and entitled WINE BOTTLE LABEL, SYSTEM AND METHOD, both of which are incorporated by reference herein in their entirety.

### FIELD OF THE INVENTION

The invention relates generally to wine bottle labels. More specifically, the invention relates to attached wine bottle labels capable of viewing during horizontal cellaring or storage.

### BACKGROUND OF THE INVENTION

Because wine is a perishable product, the optimal means of storing or cellaring wine is to lay the bottle on its side, ensuring that the wine in the bottle remains in contact with the cork. This maintains moisture in the cork, preventing shrinkage and ensuring an adequate seal of the wine bottle—which protects the wine from coming into contact with oxygen. Oxygenation contributes to the premature aging and deterioration of wine.

However, storing wine in this manner makes it nearly impossible to see the label on the wine bottle, posing difficulties in quickly identify the wine and its key attributes. For example, after placing a wine bottle into a horizontal storage system housing a collection of wine bottles, a consumer later must retrieve the right bottle of wine to consume at the right time, hopefully while the wine is still in its prime. To view a stored wine bottle, the consumer must remove the wine bottle from its stored position in order to view the label. In addition to being time-consuming and generally inconvenient, the incidental handling of the wine bottle may have negative effects on the wine quality.

In an attempt to address this situation, consumers may turn to aftermarket wine tagging or labeling systems, such as the system described in U.S. Patent Publication No. US 2006/0228508. Such systems allow a consumer to hand write wine information on a tag then hang the tag on the neck of the wine bottle while in horizontal storage. Because these systems tend to be somewhat labor intensive and unattractive, such systems have not been widely adopted by consumers.

Furthermore, from a winery's point of view, the marketing power of the wine label is greatly diminished by the low horizontal visibility of a traditional wine bottle label. Wineries go to great expense to differentiate their brands from each other with eye-catching labels easily viewed from a retail shelf However, when consumers place wine bottles bearing such labels into horizontal storage, the marketing power of the wine label is greatly diminished.

Therefore, what is needed is a wine bottle label that allows a consumer to quickly identify the wine and its attributes without removing the bottle from storage.

### SUMMARY OF THE INVENTION

One embodiment of the present invention is a bi-positional cellaring label for attaching to a wine bottle and displaying wine information. The label includes a first portion affixed to a wine bottle containing wine, and a second portion operably connected to the first portion and non-permanently affixed to the wine bottle. The second portion is adapted to be adjusted from a first position to a second position, and the second portion in the pre-cellaring position is located substantially adjacent the wine bottle, and in the cellaring position is located substantially perpendicular to the wine bottle. The label also includes indicia conveying information about the wine, printed upon the second portion, such that when the wine bottle is in a substantially horizontal position and the second portion is in the cellaring position, the indicia is viewable.

In another embodiment, the present invention is a method of displaying wine attributes of a bottled wine stored in a substantially horizontal position. The method includes receiving a bottle of wine having an attached cellaring label. The attached collaring label includes a first portion affixed to the bottle of wine a second portion non-permanently affixed to the bottle of wine, and printed indicia describing attributes of the wine. The method also includes placing the wine bottle with the attached collaring label into a cellaring position such that the bottle of wine is in a substantially horizontal position, and pulling the second portion of the attached cellaring label such that it is positioned substantially perpendicular to the bottle of wine, causing the printed indicia to be viewable to a consumer. In another embodiment, the invention comprises bottling a wine bottle including applying the label as described herein.

### BRIEF DESCRIPTION OF THE DRAWINGS

FIG. 1 is a front view of a wine cellaring label, according to an embodiment of the present invention;

FIG. 2 is a front view of the wine cellaring label of FIG. 1, attached to a neck of a wine bottle, in a pre-cellaring position;

FIG. 3 is a front view of the wine cellaring label of FIG. 1, attached at a top and bottom tab to a neck of a wine bottle;

FIG. 4 is a side view of the wine cellaring label of FIG. 1, attached at a top tab to a neck of a wine bottle, and partially pulled away from the bottle;

FIG. 5 is a front view of the wine cellaring label of FIG. 1, attached at a top tab to a neck of a wine bottle stored in a horizontal position, and pulled to a cellaring position;

FIG. 6 is a perspective view of the wine collaring label of FIG. 1, attached at a top tab to a neck of a wine bottle stored in a horizontal position, and pulled to a cellaring position;

FIG. 7 is a front view of a wine collaring label with perforations, according to an embodiment of the present invention;

FIG. 8 is a front view of the wine cellaring label of FIG. 7, fully attached to a neck of a wine bottle, and in a pre-cellaring position;

FIG. 9 is a front view of the wine cellaring label of FIG. 7, attached at a top and bottom tab to a neck of a wine bottle;

FIG. 10 is a side view of the wine cellaring label of FIG. 7, attached at a top tab to a neck of a wine bottle, and partially pulled away from the bottle;

FIG. 11 is a front view of the wine cellaring label of FIG. 7, attached at a top tab to a neck of a wine bottle stored in a horizontal position, and pulled to a cellaring position;

FIG. 12 is a perspective view of the wine cellaring label of FIG. 7, attached at a top tab to a neck of a wine bottle stored in a horizontal position, and pulled to a collaring position;

FIG. 13 is a front view of a wine cellaring capsule label attached to a vertically-positioned wine bottle, and in a pre-cellaring position, according to an embodiment of the present invention;

FIG. 14 is a side view of the wine cellaring capsule label of FIG. 13 in the pre-cellaring position;

FIG. 15 is front view of the wine cellaring capsule label of FIG. 13, attached to a horizontally positioned wine bottle in a pre-cellaring position;

FIG. 16 is a front view of the wine cellaring capsule label of FIG. 13, attached to a horizontally-positioned wine bottle, and adjusted into a cellaring position;

FIG. 17 is a perspective view of the wine cellaring capsule label of FIG. 13, attached at a top tab to a neck of a wine bottle stored in a horizontal position, and pulled to a collaring position;

FIG. 18 is a front view of a folding wine cellaring label, according to an embodiment of the present invention;

FIG. 19 is a front view of the folding wine collaring label of FIG. 18, fully attached to a neck of a wine bottle and in a pre-cellaring position;

FIG. 20 is a front view of the wine collaring label of FIG. 18, folded downward;

FIG. 21 is a side, perspective view of the wine cellaring label of FIG. 18, folded downward;

FIG. 22 is a front view of the wine cellaring label of FIG. 18, folded over a top of a horizontally-positioned wine bottle into a cellaring position;

FIG. 23 is a side, perspective of the wine cellaring label of FIG. 18, folded over a top of a horizontally-positioned wine bottle into a cellaring position;

FIG. 24 is a front view of a folding wine cellaring label, according to another embodiment of the present invention;

FIG. 25 is a front view of the folding wine cellaring label of FIG. 24, fully attached to a neck of a wine bottle and in a pre-cellaring position;

FIG. 26 is a front view of the wine cellaring label of FIG. 24, folded downward;

FIG. 27 is a side, perspective view of the wine cellaring label of FIG. 24, folded downward;

FIG. 28 is a front view of the wine cellaring label of FIG. 24, attached to a horizontally-positioned wine bottle, and folded into a cellaring position;

FIG. 29 is a side, perspective of the wine cellaring label of FIG. 24, attached to a horizontally-positioned wine bottle, and folded into a cellaring position

FIG. 30 is a front view of a folding wine cellaring label, according to yet another embodiment of the present invention;

FIG. 31 is a back view of the wine cellaring label of FIG. 30, attached to a neck of a wine bottle, in a pre-cellaring position;

FIG. 32 is a back view of the wine cellaring label of FIG. 30, folded over a top of a wine bottle;

FIG. 33 is a side view of the wine cellaring label of FIG. 30, folded over a top of a wine bottle;

FIG. 34 is a top view of the wine collaring label of FIG. 30, folded over a top of a wine bottle;

FIG. 35 is a front view of the wine cellaring label of FIG. 30, attached to a wine bottle stored in a horizontal position, and pulled to a collaring position;

FIG. 36 is a side, perspective view of the wine cellaring label of FIG. 30, attached a wine bottle stored in a horizontal position, and pulled to a cellaring position;

FIG. 37 is a front view of a medallion-style wine cellaring label, according to yet another embodiment of the present invention;

FIG. 38 is a front view of the wine cellaring label of FIG. 37, attached to a wine bottle, in a pre-cellaring position;

FIG. 39 is a side view of the wine cellaring label of FIG. 37, partially pulled away from a wine bottle;

FIG. 40 is a side view of the wine cellaring label of FIG. 37, attached to a wine bottle stored in a horizontal position, and pulled to a cellaring position;

FIG. 41 is a side, perspective view of the wine cellaring label of FIG. 37, attached a wine bottle stored in a horizontal position, and pulled to a collaring position;

FIG. 42 is a front view of a backing of wine cellaring label, according to an embodiment of the present invention;

FIG. 43 is a front view of a wine collaring label for use with the backing of FIG. 42, according to an embodiment of the present invention;

FIG. 44 is a front view of the label of FIG. 43 affixed to the backing of FIG. 42;

FIG. 45 is a front view of the wine cellaring label of FIG. 43 affixed to the backing of FIG. 42, attached to a wine bottle, in pre-cellaring position;

FIG. 46 is a front view of the wine cellaring label of FIG. 43 affixed to the backing of FIG. 42, attached to a wine bottle, partially pulled away from the bottle;

FIG. 47 is a front view of the wine collaring label of FIG. 43, attached to a wine bottle stored in a horizontal position, and pulled to a cellaring position;

FIG. 48 is a side, perspective view of the wine cellaring label of FIG. 43, attached to a wine bottle stored in a horizontal position, and pulled to a cellaring position;

FIG. 49 is a front view of a backing of wine cellaring label, according to another embodiment of the present invention;

FIG. 50 is a front view of a wine cellaring label for use with the backing of FIG. 49, according to an embodiment of the present invention;

FIG. 51 is a front view of the label of FIG. 50 affixed to the backing of FIG. 49;

FIG. 52 is a front view of the wine cellaring label of FIG. 50 affixed to the backing of FIG. 49, attached to a wine bottle, in pre-cellaring position;

FIG. 53 is a front view of the wine cellaring label of FIG. 50 affixed to the backing of FIG. 49, attached to a wine bottle, partially pulled away from the bottle;

FIG. 54 is a front view of the wine cellaring label of FIG. 50, attached to a wine bottle stored in a horizontal position, and pulled to a cellaring position;

FIG. 55 is a side, perspective view of the wine collaring label of FIG. 50, attached to a wine bottle stored in a horizontal position, and pulled to a cellaring position;

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE DRAWINGS

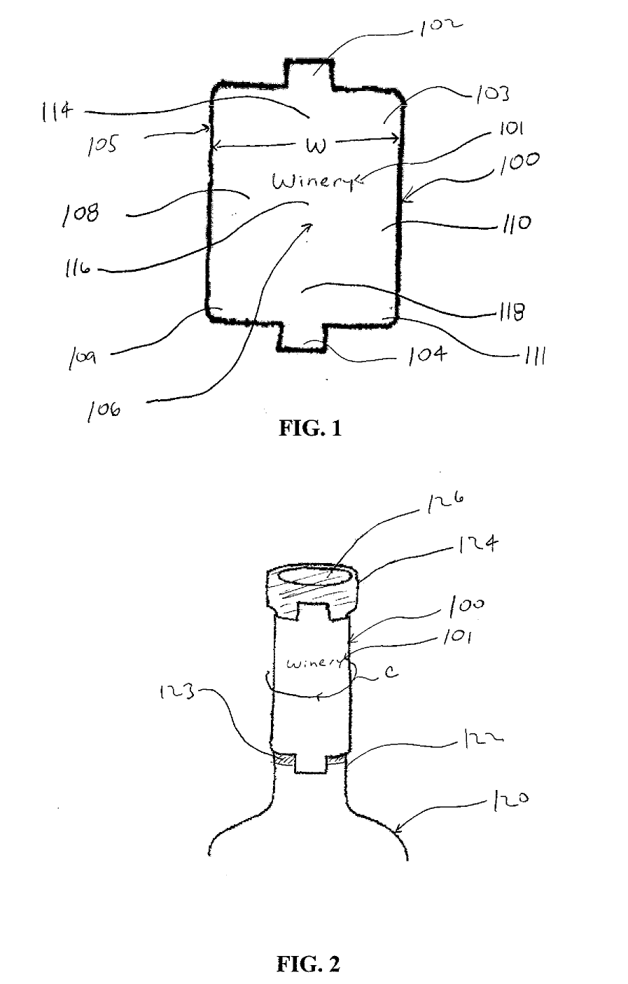

Referring to FIG. 1, in one embodiment, the present invention is a wine cellaring label 100 that includes indicia 101, top tab 102, top surface 103, bottom tab 104, bottle-side surface 105, body 106, left-side flap 108, right-side flap 110, non-permanent adhesive 112, and permanent adhesive 113. Body 106 includes top, center, and bottom portions, 114, 116, and 118, respectively.

Label 100 may be generally rectangular as depicted, but in other embodiments may be oval, round, or otherwise shaped. Furthermore, label 100 may generally be comprised of paper, plastic, or other generally flat material amenable to printing indicia 101 onto label 100.

Indicia 101 may include various types of information regarding wine attributes, wine varietal winery name, bottling date, and other relevant and information useful to a consumer of wine.

Tabs 102 and 104 extend outwardly from body 106 in a generally perpendicular direction, and in one embodiment may generally be rectangular in shape. In other embodiments, tabs 102 and 104 may be semi-circular, square, or otherwise shaped.

Flaps 108 and 110 include lower corners 109 and 111, respectively.

Non-permanent adhesive 112 may be a low tack adhesive, and is generally applied to bottle-side surface 105 of label 100. In one embodiment, adhesive 112 may coat the entire bottle-side surface 105. In other embodiments, adhesive 112 may coat only a portion of bottle-side surface 105. More specifically, in one embodiment, bottle-side surface 105 is substantially covered with adhesive 112, with the exception of top and bottom tabs 102 and 104. In another embodiment, bottle-side surface 105 is substantially covered with adhesive 112, with the exception of either or both of corners 109 and 111, and tabs 102 and 104.

Permanent adhesive 113 is a high-tack adhesive or glue used to permanently attach a portion of label 100 to bottle 120. In one embodiment, permanent adhesive 113 is applied to bottle-side surface 105 at tab 102.

Referring to FIG. 2, wine cellaring label 100 is affixed to wine bottle 120 during a labeling or bottling process. As depicted wrapped about bottle 120, label 100 is in a pre-cellaring position. Label 100 may remain in the pre-cellaring position throughout the bottling, transport, and selling processes.

In the depicted embodiment, label 100 is wrapped about bottle neck 122 of bottle 120. If bottle 120 includes a capsule 123 or other encapsulating cover, label 100 is generally affixed over capsule 123. In the embodiment depicted, label 100 wraps around neck 122, with all but top tab 102 located below a bottle lip 124. In this embodiment, all but top and bottom tabs 102 and 104 are adhered to neck 122 of bottle 120, while top tab 102 is adhered to lip 124. In other embodiments, top tab 102 extends beyond lip 124 and onto capsule top surface 126, or cork region. Bottom tab 104 extends downward along neck 122, but may or may not be covered with adhesive 112.

In this embodiment, width W of label 100 is less than bottle circumference C such that side flaps 108 and 110 do not overlap when in the pre-cellaring position. In other embodiments, width W may be greater than circumference C such that a portion of flaps 108 and 110 overlap when label 100 is in the pre-cellaring position.

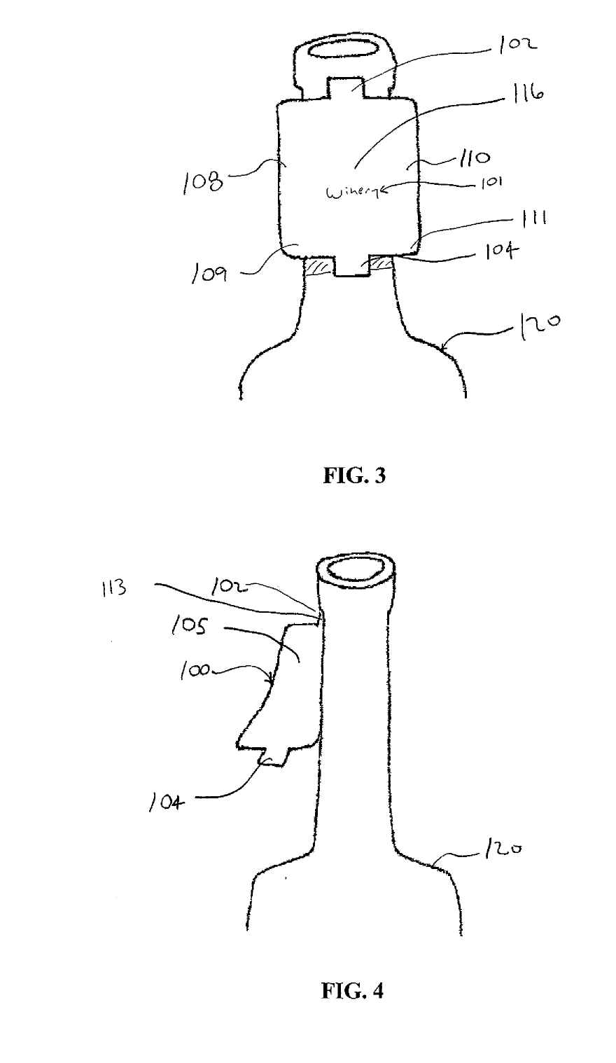

Referring to FIGS. 3-6, a consumer may pull away portions of label 100 to place it in a cellaring position. A cellaring position will be understood in its ordinary context to mean a position wherein the wine bottle is substantially horizontal, meaning more horizontal than vertical, wherein a plane parallel to the ground represents a horizontal plane. This includes the well-known storage position wherein the wine bottle is tipped slightly downward from a perfectly horizontal position, such that the wine inside the wine bottle contacts the wine bottle cork or cap.

Referring specifically to FIG. 3, side flaps 108 and 110 are initially pulled away from neck 122, leaving label 100 in a position intermediate a cellaring and pre-cellaring position. A consumer may generally pull any portion of flaps 108 and 110, but may also choose to pull on either, or both, of corners 109, 111. This is especially convenient if corners 109, 111 doe not include adhesive 112. With flaps 108 and 110 pulled away from neck 122, tab 102, body 116, and optionally, tab 104, remained adhered to bottle 120.

Referring to FIG. 4, bottom tab 104 may be pulled away from bottle 120, leaving label 100 attached to bottle 120 by tab 102. In one embodiment, bottle-side surface 105 does not include adhesive 112 at tab 104 such that a consumer may more easily lift up tab 104 and peel back label 100 from bottle 120.

Further, bottle-side surface 105 at tab 102 may be coated with permanent adhesive 113 such that tab 102 may not easily be detached from bottle 120. As such, tab 102 may be considered permanently affixed to bottle 120. Besides assuring that label 100 remains affixed to bottle 120 in the cellared position, the permanent affixation of tab 102 to bottle 120 allows label 100 to be removed, with the exception of tab 102, from bottle 120. A consumer may choose to remove label 100 from bottle 120 after drinking the wine from bottle 120 and store or save label 100 so as to recall the information on label 100 at a later date.

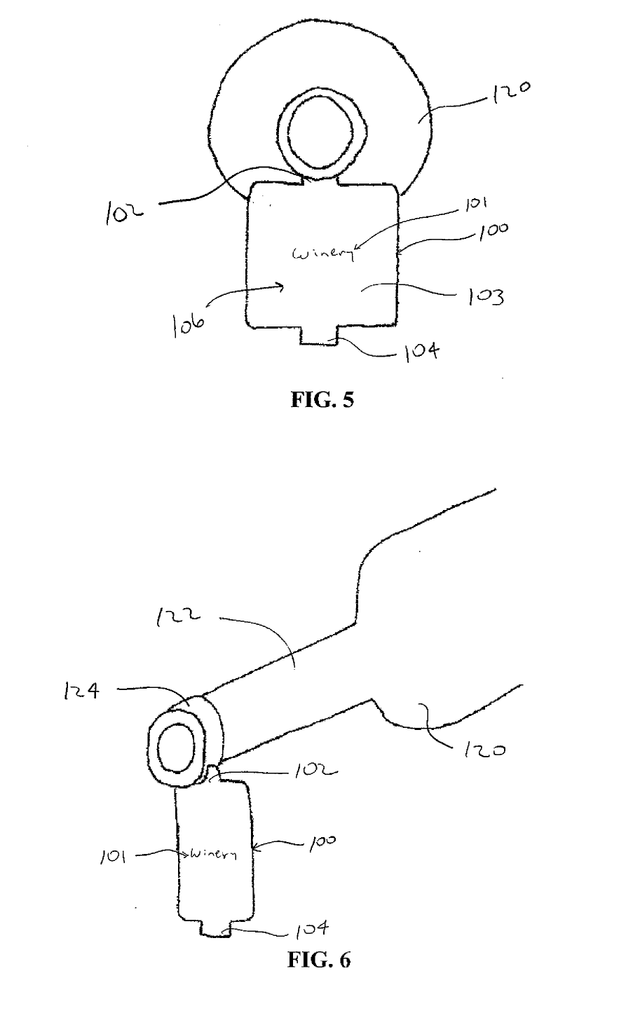

Referring to FIGS. 5-6, label 100 may be pulled and folded into a substantially perpendicular position, or cellaring position, with respect to bottle 120. In this cellaring position, contiguous label 100 bends or folds at a region connecting tab 102 to body 106. When bottle 120 is stored in a substantially horizontal position, label 100 may be pointed in a generally downward direction such that information on label 100 may be easily seen by a consumer viewing label 100 and bottle 120 in the cellared position.

When in the cellared position, label 100 with its displayed information offers the consumer immediate visual recognition of the brand varietal and wine attributes without pulling bottle after bottle from storage.

Further, label 100 serves as an inventory aid due to its visibility and detachability. After seeing that a particular type of wine is low in stock by quickly scanning labels 100 in storage, a consumer may detach one or more labels 100 to serve as a reminder to purchase additional bottles.

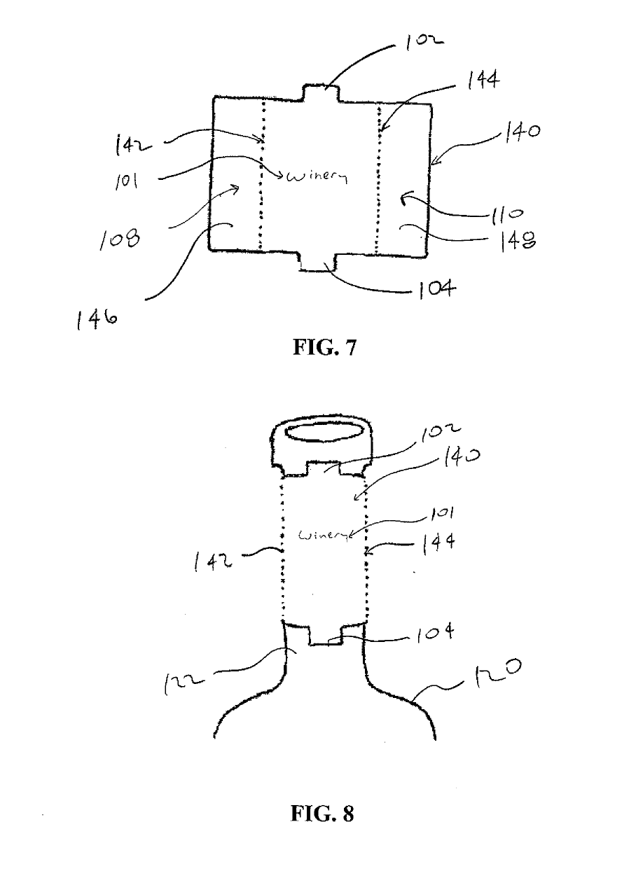

Referring now to FIGS. 7-12, in another embodiment, the present invention includes a perforated cellaring label 140.

Referring specifically to FIG. 7, in this embodiment, collaring label includes a left-side series of perforated holes 142, and a right-side series of perforated holes 144. Left-side series of perforated holes 142 and right-side series 144 each generally form a vertical line extending from the bottom to the top of label 140. Perforated hole are sized and spaced so as to facilitate tearing of the label along the vertical line formed by the holes. Other attributes of label 140 are substantially the same as those described with respect to label 100 described above.

Flaps 108 and 110 are generally longer than those of label 100 FIG. 1, and include left-flap outer portion 146 and right-flap outer portion 148, respectively. As depicted, flaps 108 and 110 do not completely wrap around neck 122 of bottle 120, though in some embodiments, they may.

Referring to FIG. 8, perforated cellaring label 140 is affixed to bottle 120 at neck 122. In the depicted embodiment, top tab 102 is permanently affixed to bottle 120 with adhesive 113, while bottom tab 104 may or may not be affixed to bottle 120 with adhesive 112. In one embodiment, body 106 is attached to bottle 120 via adhesive 112. In another embodiment, body 106, and even portions of flaps 108 and 110, may not be adhered to bottle 120.

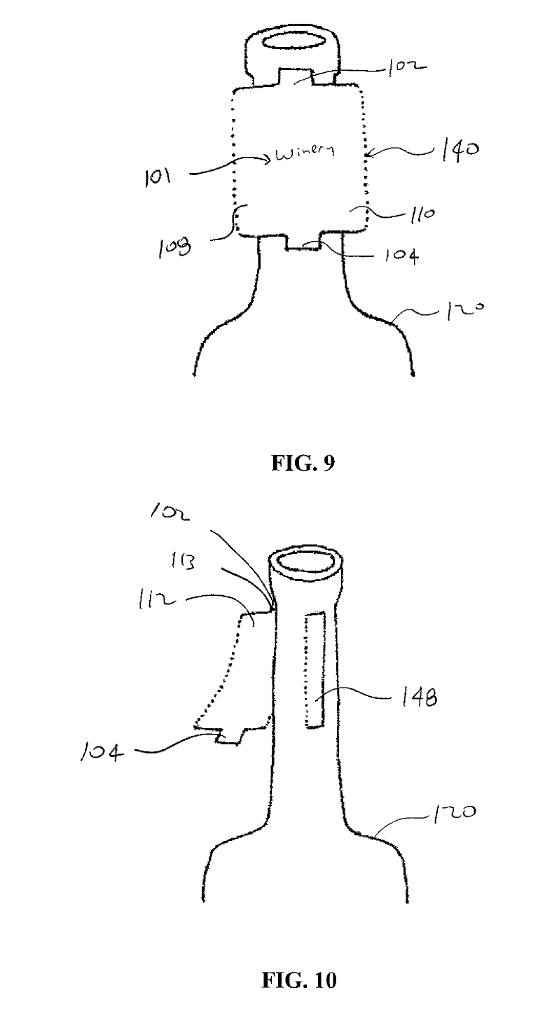

Referring to FIGS. 9-10, a consumer may pull on tab 104, thereby tearing label 140 along left-side and right-side series of perforated holes 142 and 144, and causing body 106 and flaps 108 and 110 to pull away from bottle 120. Left-flap outer portion 146 and right-flap outer portion 148 are permanently adhered via adhesive 113 to bottle 120, and remain attached to bottle 120 when label 140 is pulled away from bottle 120.

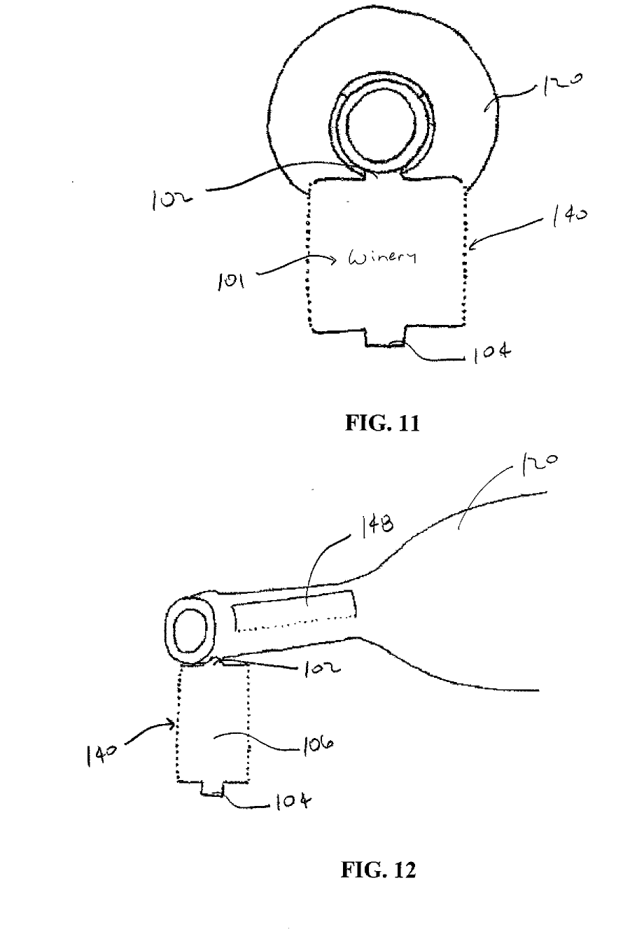

Referring to FIGS. 11 and 12, perforated label 140 is depicted in a cellaring position, hanging downward from bottle 120 which is stored in a generally horizontal position. As such, the benefits of viewing the information of label 140 as described above with respect to label 100 may be attained.

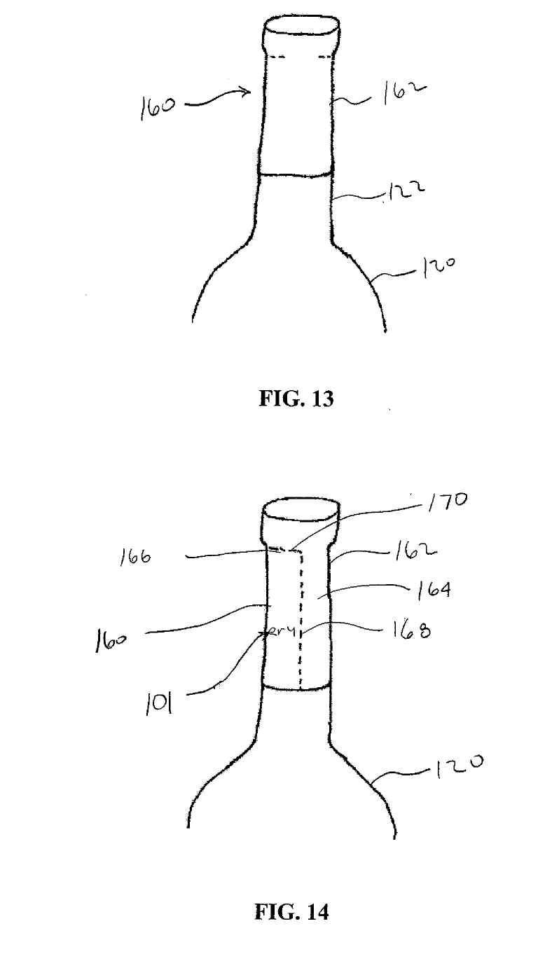

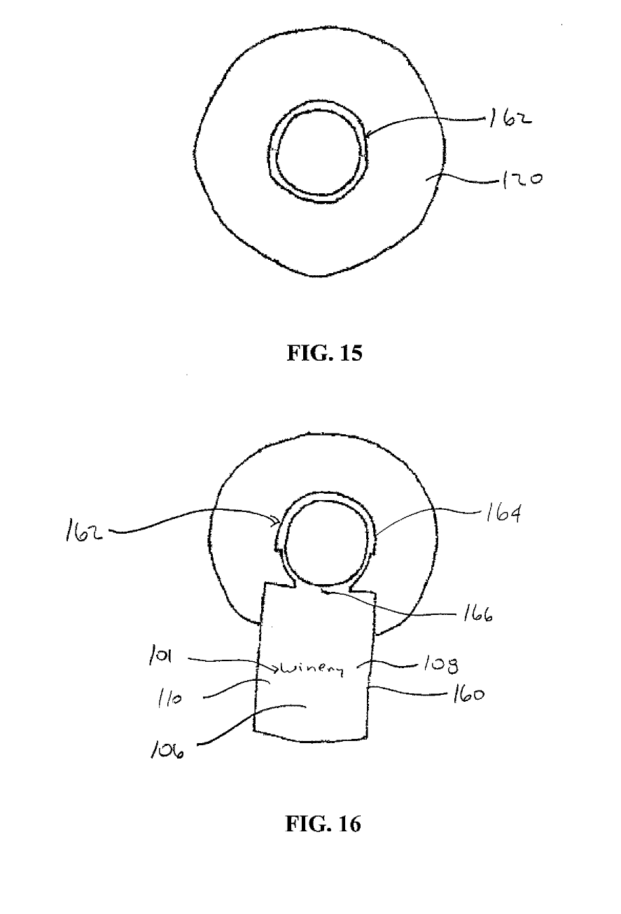

Referring to FIGS. 13-17, in another embodiment, a capsule collaring label 160 is integrated into a capsule 162 of wine bottle 120. In this embodiment, capsule 162 includes collaring label 160, fixed portion 164, joint portion 166, vertical perforations 168, and horizontal perforations 170. Similar to embodiments above, capsule cellaring label 160 includes indicia 101, center portion 106, and flaps 108.

FIGS. 13-15 depict capsule cellaring label 160 with capsule 162 affixed to wine bottle 120 in a vertical position. Capsule cellaring label 160 typically would remain in this pre-cellaring position until placed in horizontal storage in a storage system. Because capsule cellaring label 160 remains adjacent to bottle 120 as part of capsule 162, label 160 cannot be misplaced or easily damaged during the many phases of transport and handling typical to wine sales.

Referring to FIGS. 14, 16 and 17, when wine bottle 120 is placed into horizontal storage, a consumer may pull on a bottom portion of label 160 causing label 160 to begin to tear away from capsule 162 along horizontal perforations 168. Label 160 may be further separated from capsule 162 by tearing along horizontal perforations 170, leaving label 160 attached to capsule 162 only at joint portion 166. As a bottom portion of label 160 is pulled away from bottle 120, capsule 162 flexes or bends at joint portion 166, but keeps label 160 attached to fixed portion 164, and thereby to bottle 120

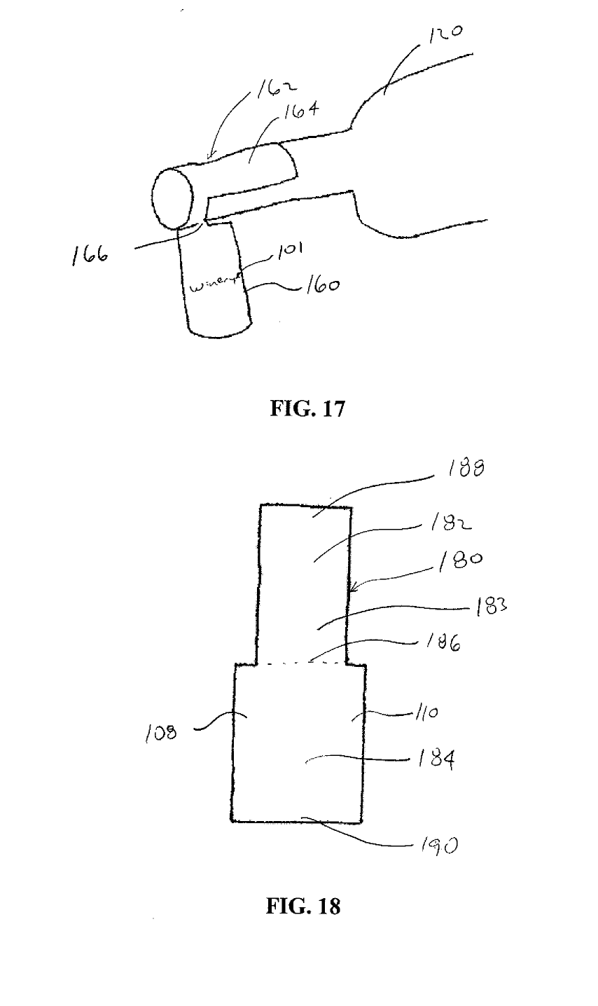

As depicted in FIG. 17, label 160 may finally be pulled into a perpendicular cellaring position such that indicia 101 may easily be viewed by a consumer.

Although fully-removable capsules bearing information about a wine are known, such capsules do not remain with the wine bottle, and are not designed to facilitate viewing of indicia during horizontal storage. See, for example, the bottle capsule information panel of U.S. Pat. No. 5,924,739 (Garbutt), which discloses a removable capsule panel bearing wine information. Unlike the present invention, the bottle capsule information panel disclosed in Garbutt is designed to make wine information viewable to a consumer only after removal from the capsule.

Referring now to FIGS. 18-23, in another embodiment, a cellaring label 180 is partially detached from bottle 120, unfolded, then pulled up over the top of bottle 120, covering a cork or seal of bottle 120 as it hangs downward and perpendicular to bottle 120.

Cellaring label 180 includes indicia 101, extension portion 182, top surface 183, body portion 184, bottom surface 185, and fold region 186. Extension 182 includes top region 188, while body portion 184 includes flaps 108, 110 and bottom portion 190. Cellaring label 180 may also include adhesive 112 in some embodiments.

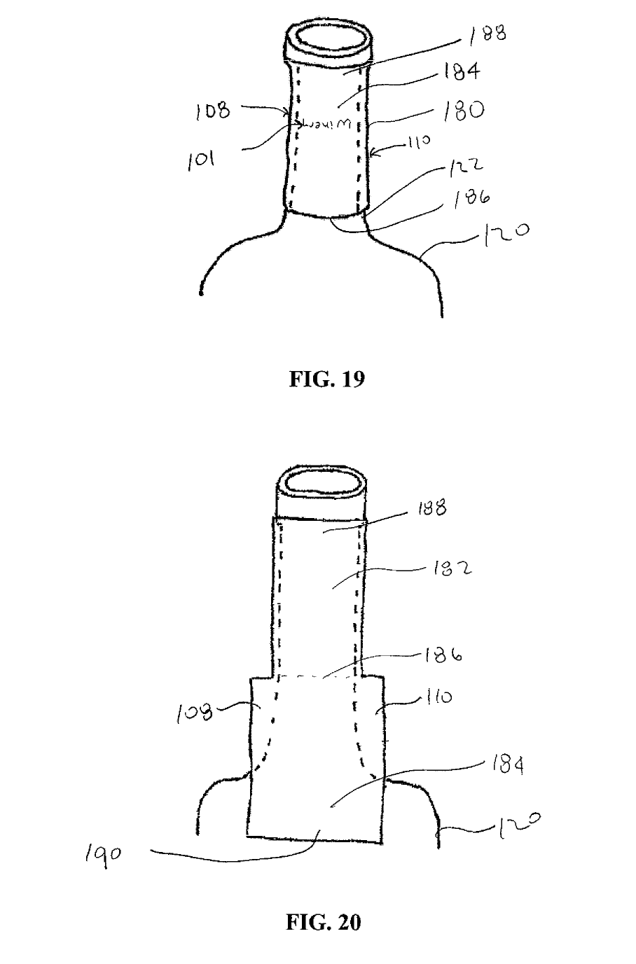

FIG. 19 depicts collaring label 180 affixed to bottle 120, and in a pre-cellaring position as it would leave a winery. Label 180 is permanently attached to bottle 120 at top portion 188 using permanent adhesive 113 (not depicted). Label 180 is folded along fold region 186 such that body portion 184 is adjacent to extension 182, or top surface 183 at extension 188 is adjacent to top surface 183 at top portion 188. Flaps 108 and 110 wrap around neck 122 of bottle 120, and are held to extension 188 and/or bottle 120, with adhesive 112. As such, body portion 184 is not adhered to bottle 120, but flaps 108 and 110 are attached to bottle 120 via non-permanent adhesive 112.

FIGS. 20 and 21 depict cellaring label 180 in a position intermediate the pre-cellaring and cellaring positions. As depicted, a consumer has pulled bottom portion 190 downward and away from neck 122, such that indicia O1 may not yet be easily viewed.

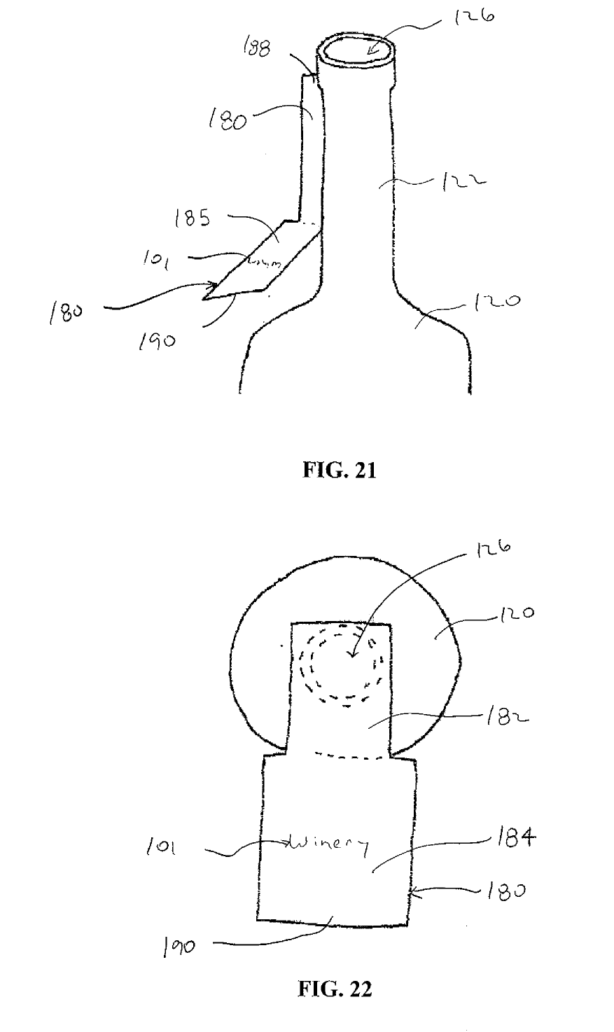

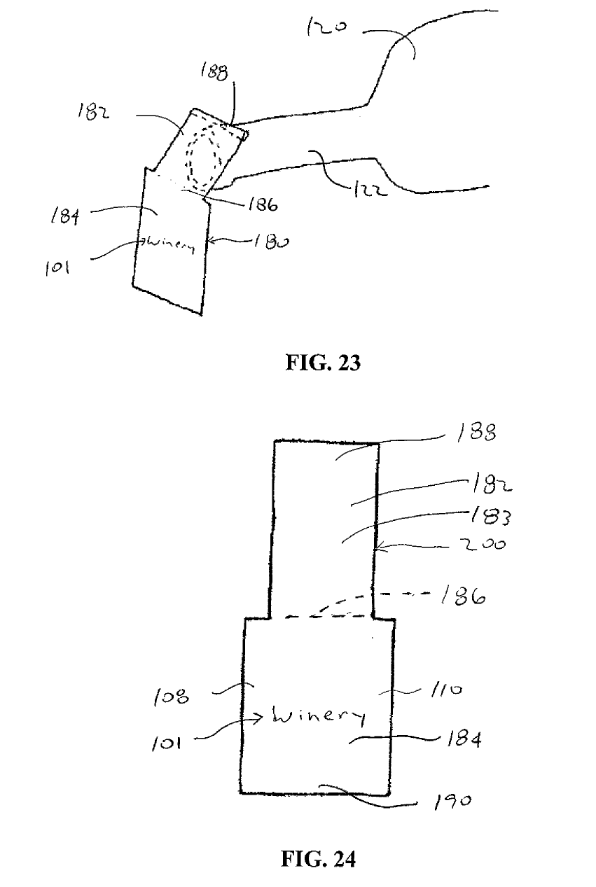

Referring to FIGS. 22 and 23, bottom portion 190 of label 180 may be pulled upward and over the top of bottle 120, such that it covers capsule top region 126. In this collaring position, body portion 184 hangs downward and perpendicular to bottle 120. Body 184 may be pivoted or folded along fold region 186 such that it hangs as needed. In this cellaring position, indicia 101 may easily be viewed by a consumer while bottle 120 is in the horizontal storage position.

Additionally, adhesive 112 may be placed upon portions of top surface 183 or bottom surface 185 of label 180 to hold portions of label 180 to bottle 120, thereby assisting a consumer in placing label 180 into a most convenient cellaring position.

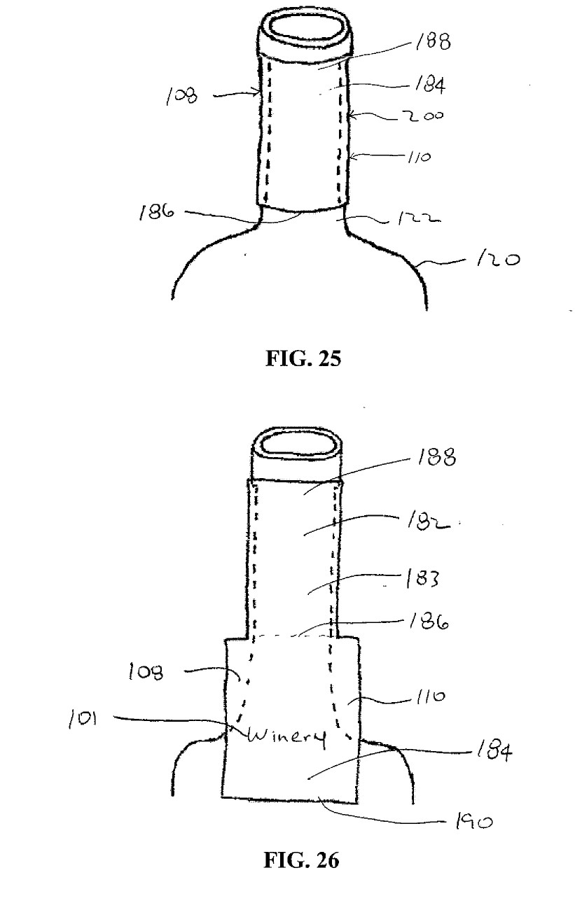

Referring to FIGS. 24-29, a cellaring label 200 is very similar to cellaring label 180 described above, and includes all of the components of label 180. However, in this embodiment, indicia 101 is placed on a top side 183 of the cellaring label, rather than a bottom side 185. Further, cellaring label 200 is not folded up over capsule top region 126, but rather hangs downward from bottle 120.

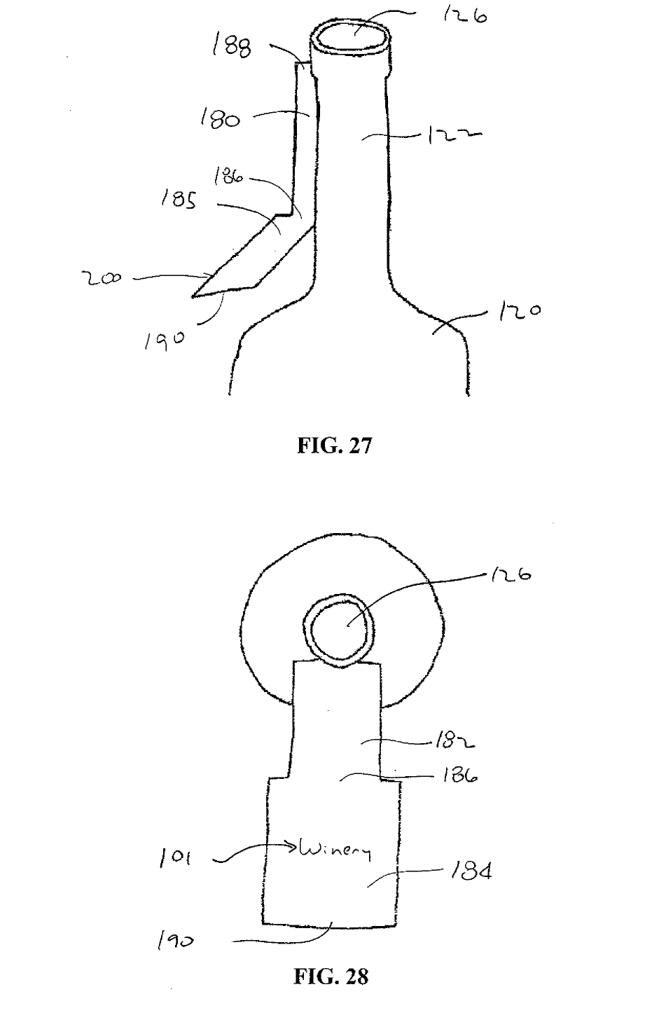

More specifically, and with reference to FIGS. 26 and 27, a consumer pulls bottom portion 190 downward and away from neck 122 as before, bending body portion 184 away from extension 182, or by unfolding label 200. In this embodiment, a consumer then continues to unfold label 200 at fold region such that extension 182 and body portion 184 are no longer adjacent one another, and may form an angle greater than ninety degrees.

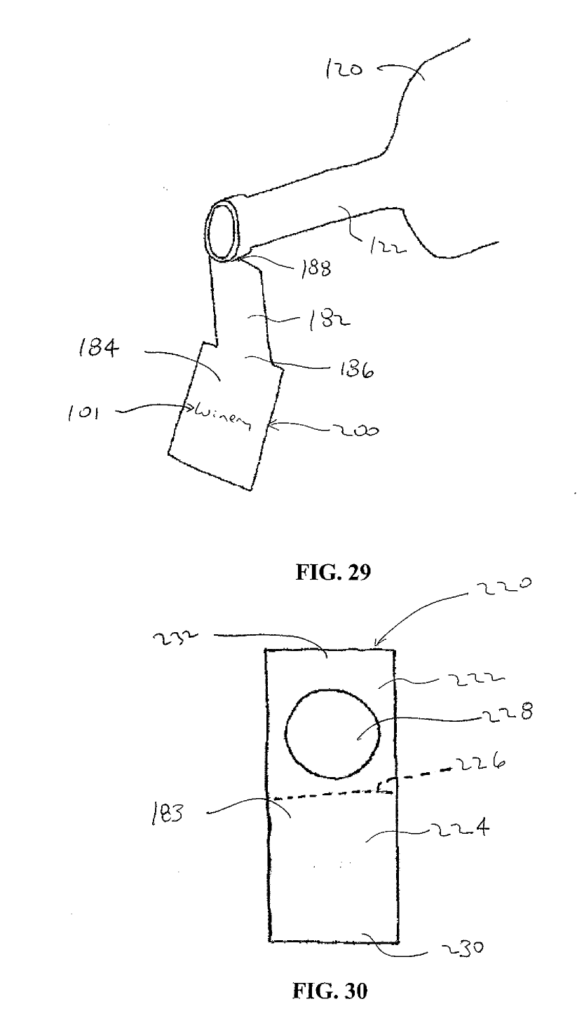

Accordingly, label 200 is in the cellaring position as depicted in FIGS. 28 and 29, such that label 200 and its indicia 101 are easily viewed.

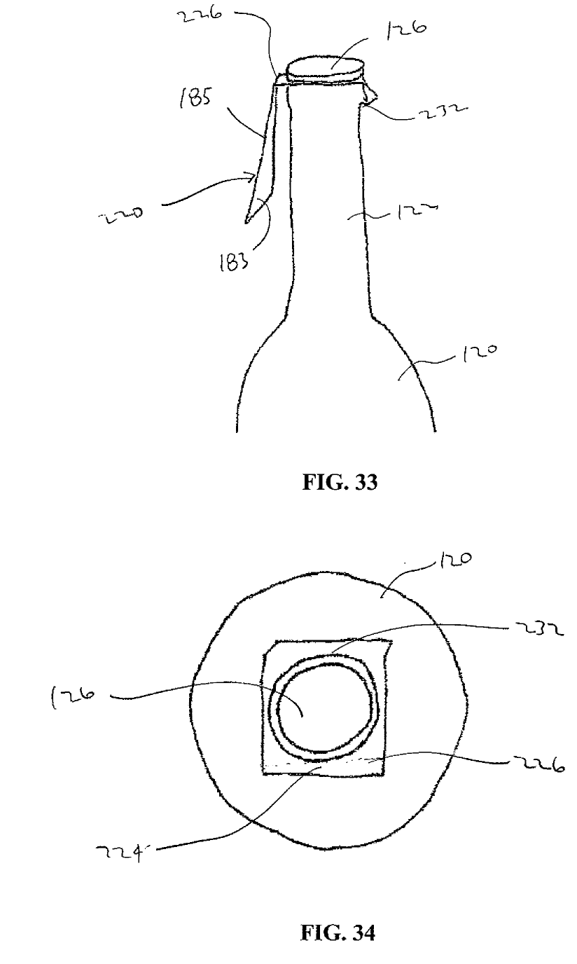

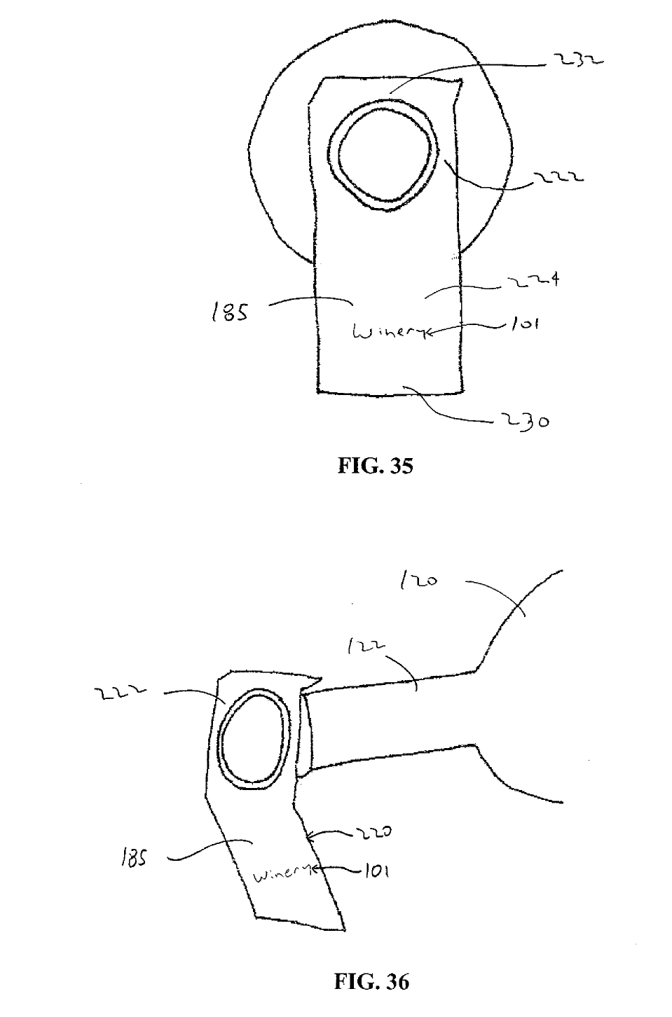

Referring to FIGS. 30-36, in another embodiment that shares some of the qualities of cellaring label 180 as depicted in FIGS. 18-23, a cellaring label 220 is detached and unfolded from a back side of neck 122 and pulled over the top of bottle 120 such that capsule region 126, or a cork or cork covering material, is viewable as label 220 hangs downward in the cellaring position.

More specifically, and with respect to FIG. 30, cellaring label 220 includes indicia 101, top surface 183, top portion 222, bottom portion 224, and fold region 226. Label 220 also defines an opening 228. Bottom portion 224 includes a lower bottom portion 230, while top portion 222 includes an upper top portion 232.

Opening 228 is sized such that it is slightly larger than the circumference of the top of a standard wine bottle 120, such that the top of bottle 120 may be inserted through opening 228.

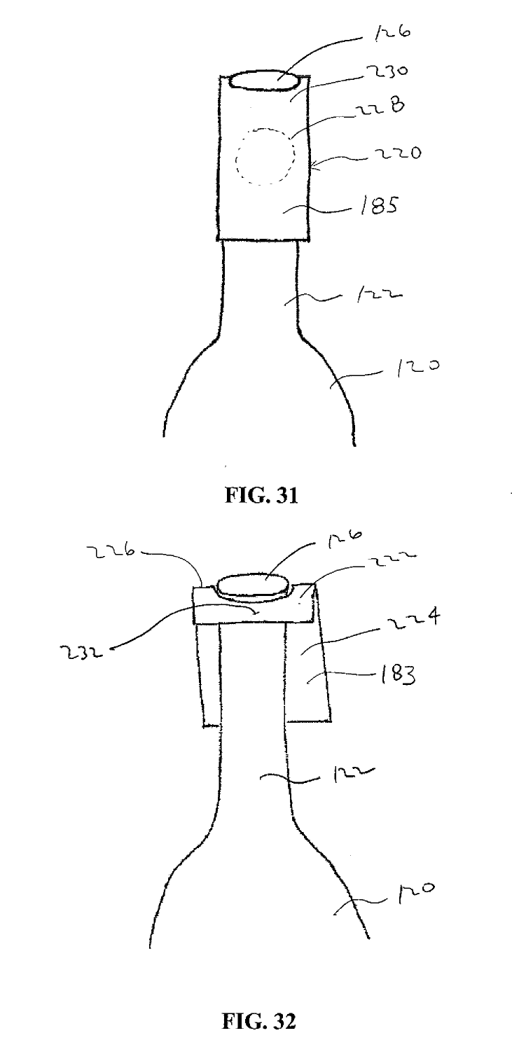

Referring to FIG. 31, label 220 is depicted attached to bottle 120 at neck 122 or capsule 123. Upper top portion 232 is permanently affixed to bottle 120 using permanent adhesive 113. Label 220 is folded at fold region 226 such that bottom portion 224 is generally adjacent top portion 222, and covering opening 228. Adhesive 112 on portions of bottom side 185 of top portion 222 holds label 220 to bottle 120. In some embodiments, adhesive 112 may hold bottom portion 224 to top portion 222 when label 220 is folded and in the pre-cellared position. As such, label 220 may be peeled away from bottle 120, except at upper top portion 222, which is permanently affixed to bottle 120.

Referring to FIGS. 31-36, a consumer may initially lift the sides of label 220 to peel them away from bottle 120, then unfold label 220 by peeling or pulling bottom portion 230 downward and away from bottle 120. Label 220 is then pulled up and over region 126 such that the top of bottle 120 may be inserted through hole 128.

As such, bottom portion 224 of label 220 hangs downward and generally perpendicular to bottle 120 when in the cellaring position, such that indicia 101 may be easily viewed by a consumer.

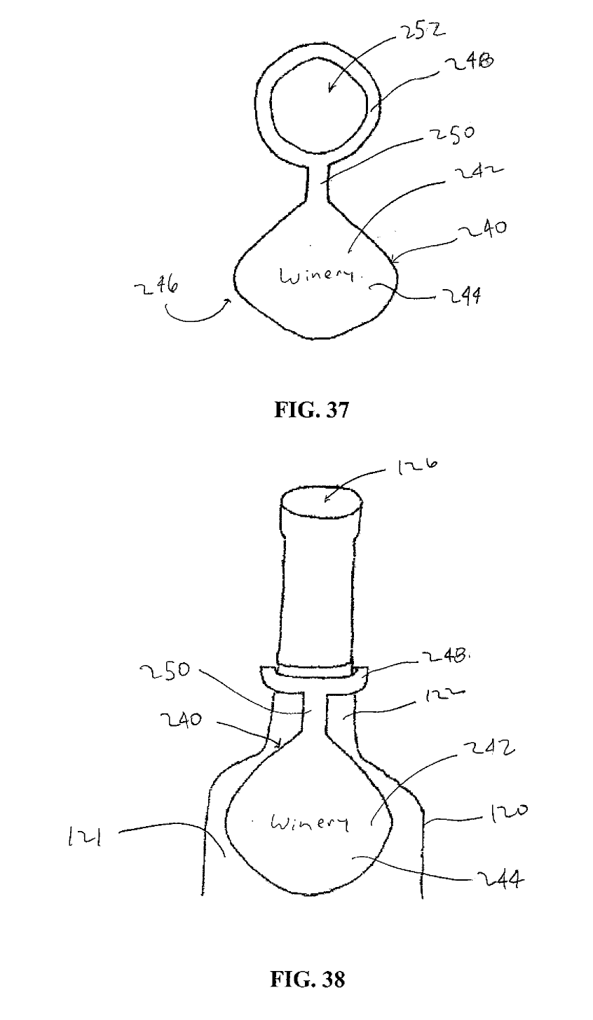

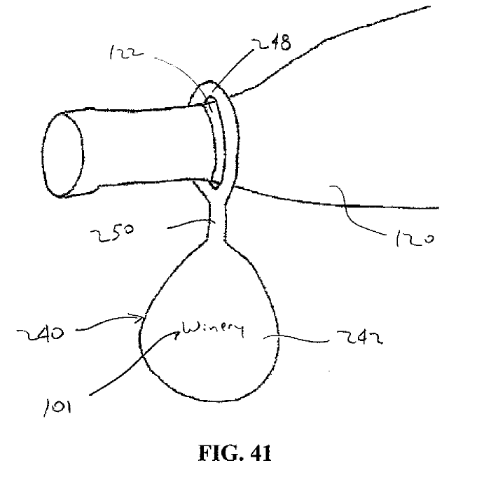

Referring to FIGS. 37-41, in another embodiment, a cellaring label 240 is attached to bottle 120 both at its neck 122 and back side 121.

Referring specifically to FIGS. 37 and 38, cellaring label 240 includes indicia 101, medal portion 242 having top surface 244 and bottle-side surface 246, annular portion 248 and connecting portion 250. Label 240 further defines hole 252 which may have a diameter slightly larger than a diameter of neck 122 such that bottle 120 may be inserted through hole 252. In one embodiment, indicia 101 is printed upon top surface 244.

Medal portion 242 may be of any shape that may be attractive to a consumer and conforms easily to bottle 120.

Annular portion 248 and connection portion 250 may be an integral part of label 240, comprised of the same label material such as paper or plastic. However, in other embodiments, annular portion 248 and in some cases connection portion 250 may comprise a string or ribbon attached to medal portion 242.

During bottling, annular portion 248 is placed over neck 122 of bottle 120 such that the top of bottle 120, including region 126, protrudes through hole 252. Non-permanent adhesive 112 is applied to bottle-side surface 246 such that it may be adhered to a back side 121 of bottle 120. As such, label 240 is attached to bottle 120 and in the pre-cellaring position, ready for transport and sale.

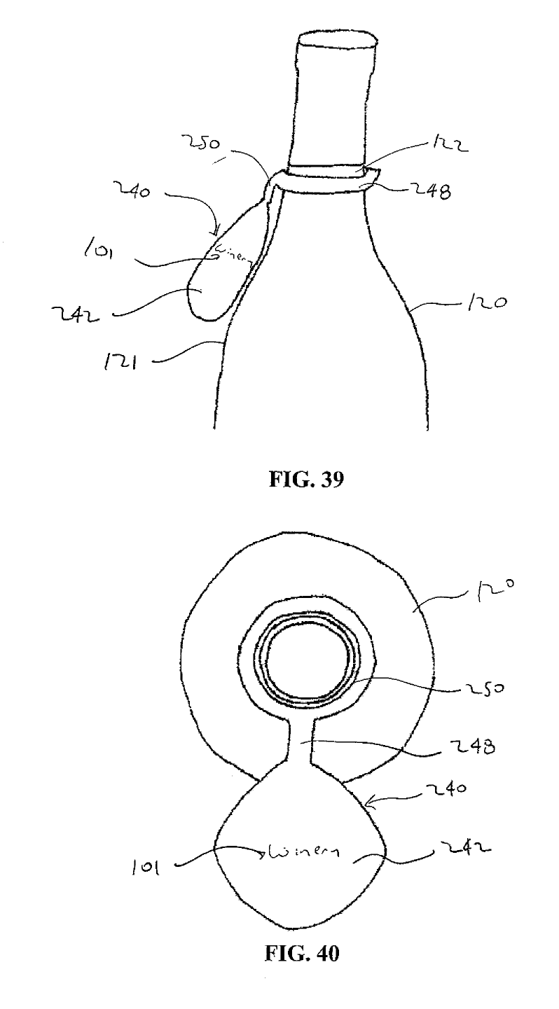

Referring to FIGS. 39-41, at the time of cellaring, a consumer may peel back medal portion 244 of label 240 such that it is no longer in contact with bottle 120. Medal portion 242, bearing indicia 101, hangs from neck 122 generally downward and generally perpendicular to bottle 120. In the cellaring position, indicia 101 and label 240 is easily viewed by a consumer.

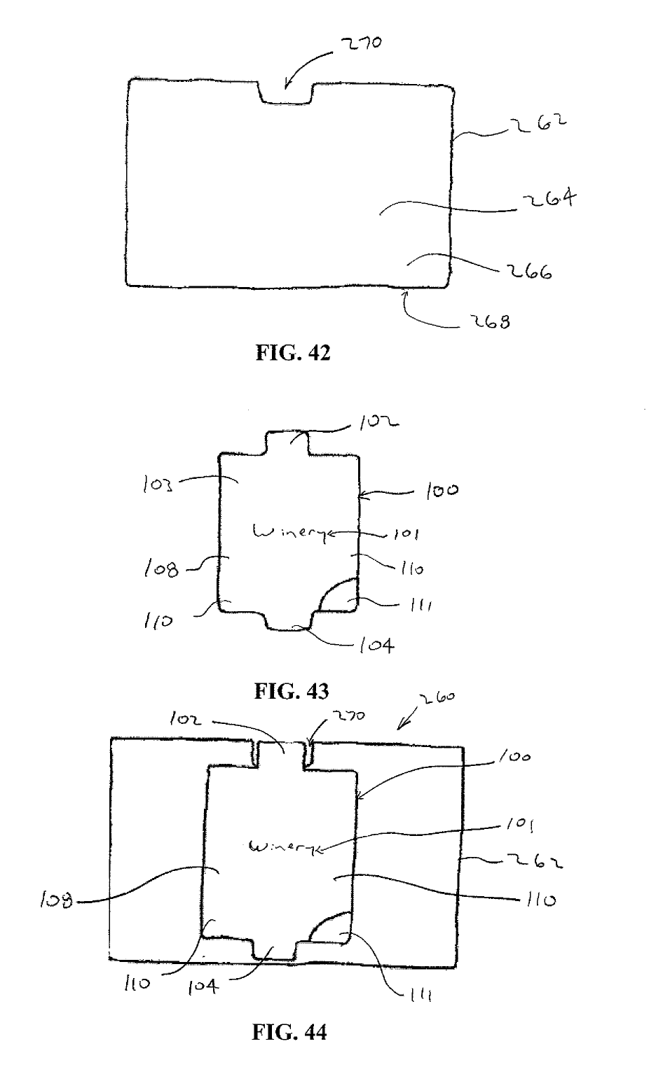

Referring to FIGS. 42-48, in another embodiment, a cellaring label 260 includes cellaring label 100 described above and depicted in FIGS. 1-6, and backing label 262.

Referring specifically to FIG. 42, in one embodiment, backing label 262 may generally be rectangular in shape, and includes a main portion 264, top surface 266, bottle-side surface 268, and defines a notch 270. Notch 270 is sized to be slightly larger than tab 102, such that a significant portion of tab 102 of label 100 may be in contact with bottle 120.

Backing 262 in some embodiments may be generally rectangular as depicted, but in other embodiments may be shaped so as to accommodate a variety of bottle shapes and sizes. Backing 262 may be comprised of a material such as paper or plastic, or other material, such that label 100 may easily be adhered to backing 262 using a non-permanent adhesive 112. Further, backing 262 may include indicia 101 or other graphics useful or pleasing to a consumer.

Backing 262 is wrapped about neck 122 of bottle 120, and affixed to bottle 120 using permanent adhesive 113. In other embodiments, backing 262 may be adhered with a non-permanent adhesive 112 or with another type of adhesive or glue. In other embodiments, backing 262 is applied to bottle 120 as a pressure-sensitive label. Further, backing 262 may wrap completely around neck 122, or may only wrap partially around neck 122.

Label 100 may be pre-affixed via adhesive 112 to backing 262 prior to the bottling process, with backing 262 providing a consistent and predictable surface for label 100 to adhere to prior to removal by a consumer. Although bottle-side surface 105 may substantially be coated with adhesive 112 to adhere label 100 to backing 262, in some embodiments, center portion 106, or other portions of surface 105 may be free of adhesive, while flaps 108 and 110 are coated with adhesive 112.

More specifically, tab 104 may not include adhesive 112 so as to facilitate lifting by a consumer. In other embodiments, a corner 111 or even 110 may also not include adhesive 112 in order to facilitate lifting by a consumer

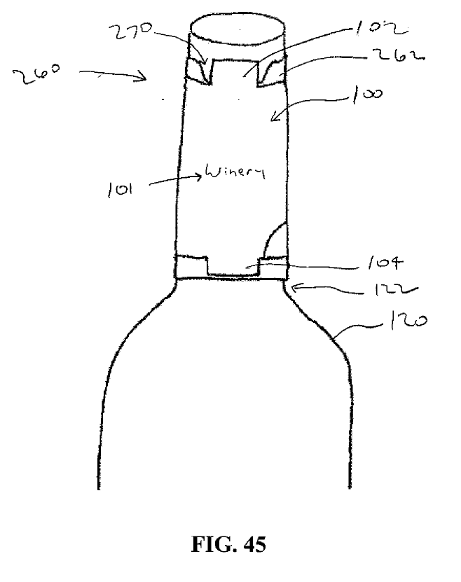

Referring to FIG. 45, backing 262 is wrapped about, and adhered to neck 122, or alternatively, capsule 123, or both, of bottle 120. As before, tab 102 of label 100 is permanently affixed or attached to bottle 120 via permanent adhesive 113.

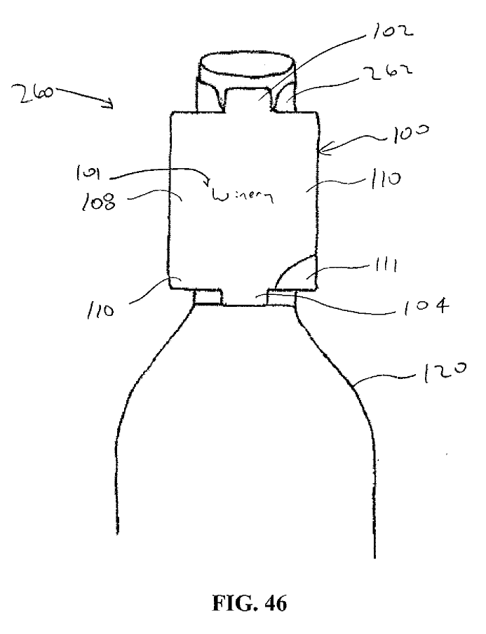

Referring to FIG. 46, flaps 110 and 108 of label 100 may be peeled or pulled up from backing 262 and away from bottle 120. Alternatively, corners 110, 111, and/or tab 104 may also be used to begin detaching label 100 from backing 262.

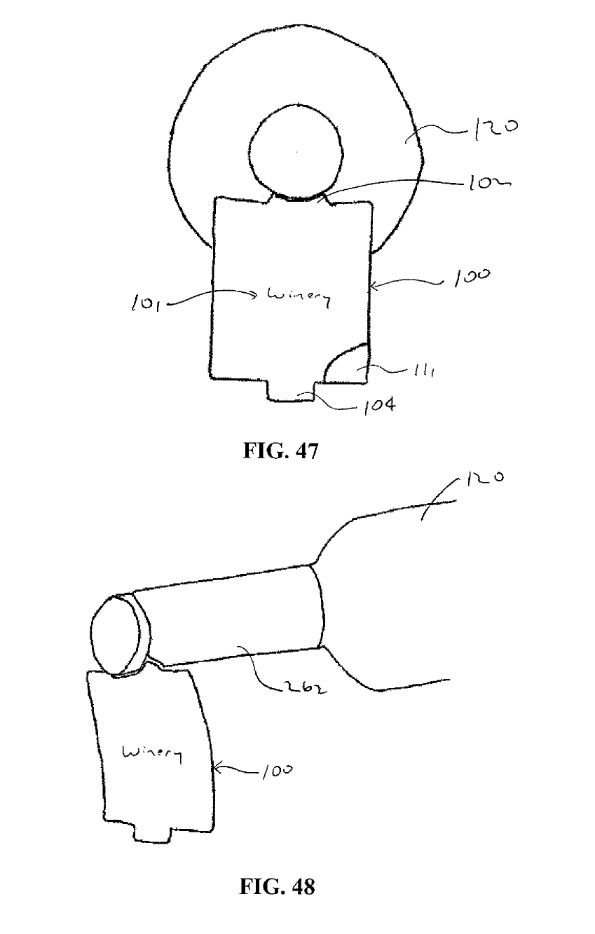

Referring to FIGS. 47 and 48, label 100 is pulled into a cellared position, substantially away from backing 262, such that it hangs downward and substantially perpendicular to bottle 120.

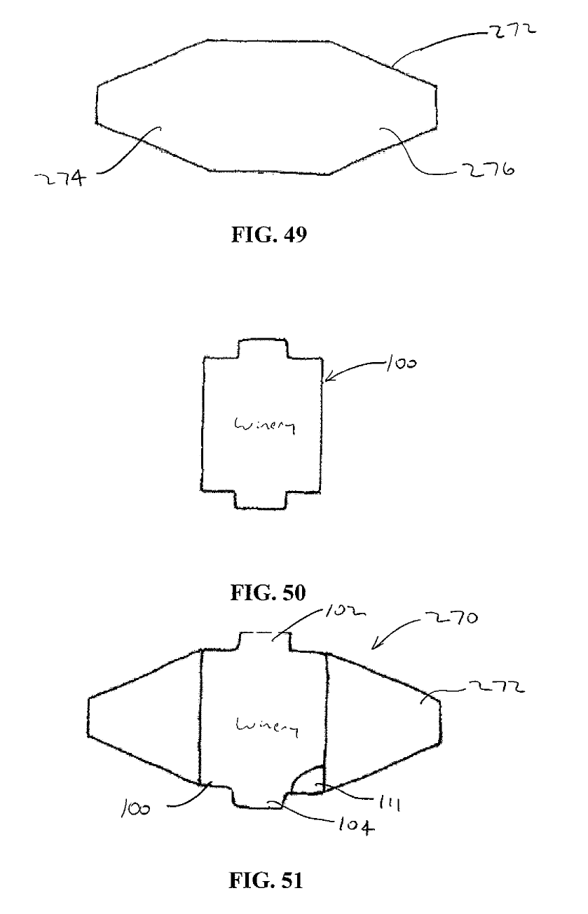

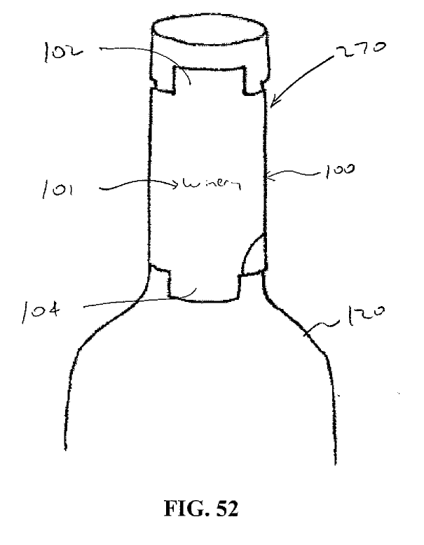

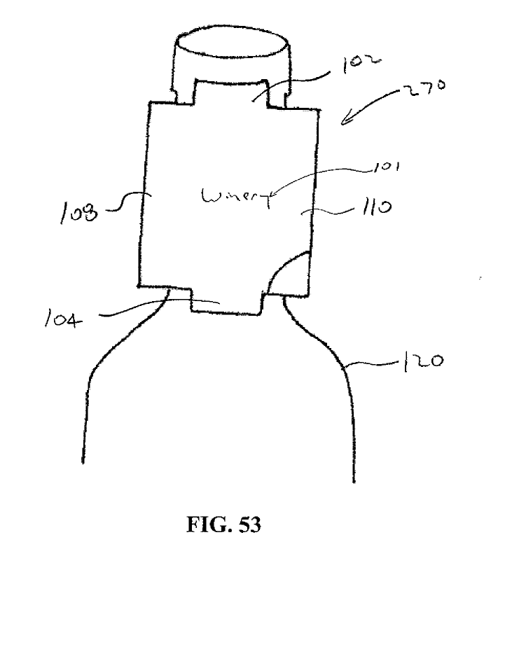

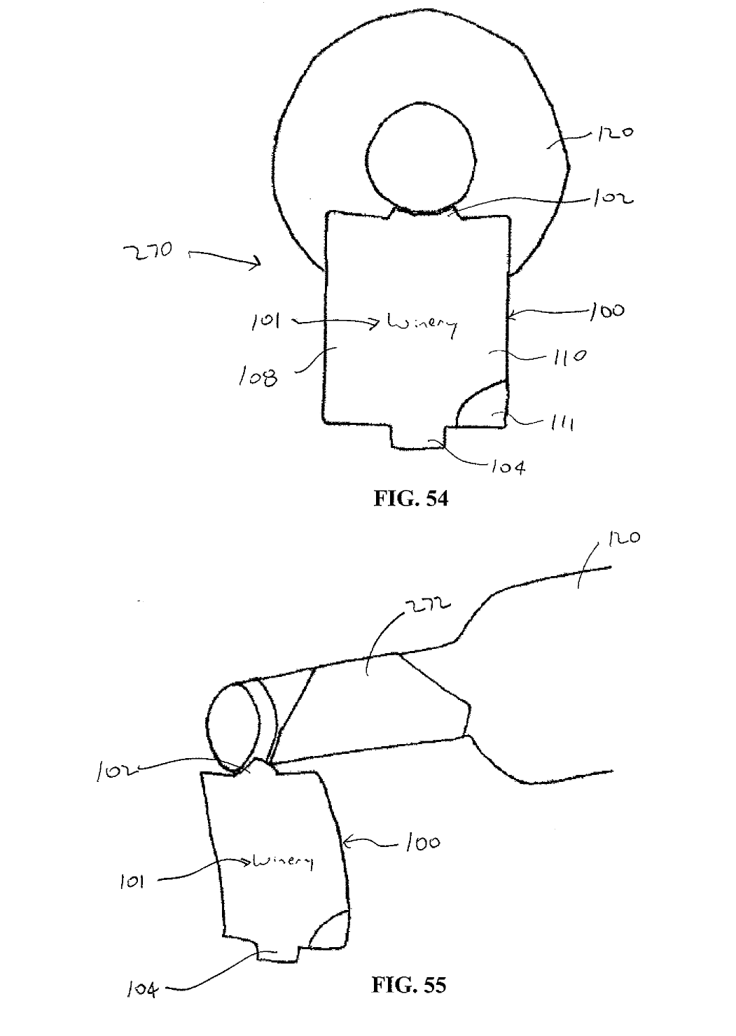

Referring to FIGS. 49-55, another embodiment of a cellaring label, collaring label 270, also includes a backing, backing 272. Cellaring label 270 includes all of the components and attributes of collaring label 260 as described above, with the exception of backing 272, which differs from backing 262.

Referring specifically to FIG. 49, backing 272 is an angle-cut backing, and includes tapered tabs 274 and 276. Tabs 274 and 276 may be shaped as shown, or may be rounded or otherwise shaped. By including tabs 274 and 276, backing 272 may be more universally applied to a variety of bottle 120 shapes and sizes.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A wine bottle with a bi-positional cellaring label for displaying wine information, the label comprising:
a first portion affixed to the neck of a wine bottle containing wine;
a second portion operably connected to the first portion and non-permanently affixed to the wine bottle, wherein the second portion is adapted to be adjusted from a first position to a second position, and wherein the second portion in the pre-cellaring position is located substantially adjacent the wine bottle, and in the collaring position is located substantially perpendicular to the wine bottle;
indicia conveying information about the wine, printed upon the second portion, such that when the wine bottle is in a substantially horizontal position and the second portion is in the cellaring position, the indicia is viewable.

2. The wine bottle of claim 1, wherein the first portion is permanently attached to the wine bottle.

3. The wine bottle of claim 1, further comprising an adhesive adapted to non-permanently affix the second portion to the wine bottle.

4. The wine bottle of claim 1, wherein the first portion and the second portion are contiguous such that the cellaring label bends at a region connecting the first portion to the second portion when the second portion is adjusted to the cellaring position.

5. The wine bottle of claim 1, wherein the second portion comprises left and right flaps, a body, and perforated holes, and wherein the left and right flaps are permanently affixed to the wine bottle and separated from the body by the perforated holes such that when the second portion is adjusted to the collaring position, the body tears away from the left and right flaps, leaving the left and right flaps affixed to the wine bottle.

6. The wine bottle of claim 1, wherein the first and second portions comprise portions of a wine bottle capsule.

7. The wine bottle of claim 1, wherein the second portion comprises a fold region, and is folded along the fold region while in the pre-cellaring position, and is unfolded to adjust to a cellaring position.

8. The wine bottle of claim 7, wherein the second portion is adapted to be pulled over a top region of the wine bottle.

9. The wine bottle of claim 8, wherein the second portion further comprises an opening, and wherein the top region of the wine bottle protrudes through the opening when the second portion is in the cellaring position.

10. The wine bottle of claim 1, further comprising a backing label affixed directly to the wine bottle, and wherein the second portion is affixed directly to the backing label.

11. The wine bottle of claim 10, wherein the backing label is permanently affixed to the wine bottle and the second portion is non-permanently affixed to the backing label.

12. A wine bottle with a cellaring label for attaching to a wine bottle and displaying wine information, the label comprising:
a first portion adapted to fit over the neck of a wine bottle containing wine;
a second portion operably coupled to the first portion and adapted to be affixed to a surface of the wine bottle, the second portion comprising:
indicia printed on a top surface of the second portion and conveying wine information;
non-permanent adhesive applied to a bottle-side surface of the second portion for affixing the second portion to the surface of the wine bottle; and
wherein the second portion is further adapted to be removed from the surface of the wine bottle, such that the second portion hangs from the first portion in a substantially perpendicular position to the wine bottle when the wine bottle is stored in a substantially horizontal position, thereby displaying the indicia.

13. The wine bottle of claim 12, wherein the first portion comprises one of a ribbon and a string.

14. The wine bottle of claim 12, wherein the second portion comprises a medallion shap

15. A method of bottling wine, the method comprising:
providing a wine bottle with a neck;
providing a bi-positional label with a lesser portion and a greater portion, the greater portion having text thereon providing information concerning a specific wine;
attaching the lesser portion to the wine bottle whereby it is fixed to the neck of the wine bottle;
releasably retaining the greater portion to neck of the wine bottle whereby said greater portion is releaseable therefrom to extend from the neck of the wine bottle to provide the information in a viewable manner when the bottle is positioned substantially horizontally; and
filling the wine bottle with the specific wine.

16. A method of displaying wine attributes of a bottled wine stored in a substantially horizontal position, comprising:
receiving a bottle of wine having an attached cellaring label, wherein the attached cellaring label includes a first portion affixed to the bottle of wine, a second portion non-permanently affixed to the bottle of wine, and printed indicia on the second portion describing attributes of the wine;
placing the wine bottle with the attached cellaring label into a collaring position such that the bottle of wine is in a substantially horizontal position;
releasing the second portion of the attached cellaring label such that it is positioned substantially perpendicular to the bottle of wine, causing the printed indicia to be viewable to a consumer.

17. The method of claim 16, wherein the attributes of the wine include a wine brand, wine varietal, and bottling year.

18. The method of claim 16, wherein the first portion is permanently affixed to the bottle of wine.

19. The method of claim 16, further comprising detaching the second portion from the bottle of wine and using the second portion as an aid to recalling the wine attributes after detachment of the second portion.

20. A wine bottle with a bi-positional collaring label for displaying wine information, the label comprising:
a first portion affixed to a wine bottle containing wine;
a second portion operably connected to the first portion and non-permanently retained along the neck of the wine bottle in a first position, wherein the second portion is manually releasable from the first position to a second position wherein in the second position the second portion is extending outwardly from the neck of the wine bottle such that the second portion is upright when the bottle is in a substantially horizontal position; and
indicia conveying information about the wine, printed upon the second portion, such that when the wine bottle is in a substantially horizontal position and the second portion is in the cellaring position, the indicia is viewable.
